(19) United States
(12) Patent Application Publication
(10) Pub. No.: US 2005/0046997 A1
(43) Pub. Date: Mar. 3, 2005

(54) Disk drive

(75) Inventors: Shinichi Kimura, Kanagawa (JP); Hiroki Kitahori, Kanagawa (JP); Satoshi Matsumura, Kawasaki-shi (JP); Hiroshi Matsuda, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies Netherlands, B.V., Amsterdam (NL)

(21) Appl. No.: 10/892,263

(22) Filed: Jul. 14, 2004

(30) Foreign Application Priority Data
Sep. 3, 2003 (JP) 2003-311187

(51) Int. Cl. G11B 17/00

(52) U.S. Cl. 360/97.01

(57) ABSTRACT

Deformation due to thermal shrinkage of a shock absorbing member surrounding a main part of a disk drive-is reduced. In one embodiment, a frame bumper covers a case (base plate) included in a disk drive excluding part of the case provided with a connector. A curved flexible part is formed in a part, opposite the connector, of the frame bumper. The curved flexible part extends or contracts to absorb the deformation of the frame bumper due to thermal shrinkage. The curved flexible part is formed in a substantially middle part of a cross part extending between side parts provided with slots. Slits are formed above and below, respectively, of the curved flexible part to enable the frame member to deform upward and downward relative to the flexible part.

### BACKGROUND OF THE INVENTION

The present invention relates to a highly shock-resistant disk drive and, more particularly, to a disk drive scarcely subject to deformation due to the thermal shrinkage of a shock-absorbing member.

Various types of portable recording media are provided for various devices including personal computers (PC) and digital cameras to store data. Efforts have been made in recent years to provide recording media having a small size and a large storage capacity. For example, a small, portable magnetic disk drive has been proposed. This proposed disk drive has a new assembly construction based on the Compact Flash® commercially available from SanDisk Corporation, i.e., one of standard small memory cards.

A large-capacity miniature hard magnetic disk drive conforming to the standard of Compact Flash Type 2 is provided with a 1 in. diameter magnetic disk having a storage capacity of 1 GB, and has a weight on the order of only 16 g. FIG. 5 shows a disk drive 1, and a PC card 2. The disk drive 1 is loaded into the PC card 2. The PC card 2 to be used in combination with the disk drive 1, similarly to the disk drive 1, is based on standards such as the standards of Compact Flash Type 2. The disk drive 1 can be inserted in the PC card 2. The PC card 2 is provided with a slot 201 in which the connector of the disk drive 1 is fitted, and a guide rail 202 for guiding the disk drive 1.

This portable, miniature hard disk drive is provided, in addition to the magnetic disk (disk) for storing data, a spindle motor for rotating the disk, a read/write head for writing and reading data to and from the disk, and an actuator for moving the read/write head in a direction along a radius of the disk.

Functional components including a disk, a spindle motor, a read/write head and an actuator of such a miniature hard disk drive having compact construction are formed very minutely. Therefore, it is possible that the miniature hard disk drive is damaged and does not function normally if the hard disk drive is dropped or shocked. To solve such a problem, a disk drive disclosed in Japanese Patent Laid-open No. 2002-15553 (pp. 5-6, FIGS. 3 and 4) is provided with shock absorbing members at its corners (four corners) to absorb external shocks. This reference forms a guide groove to be used for combining the disk drive with another device to meet Compact Flash standards.

The Japanese patent reference discloses a technique relating to a disk drive excellent in shock resistance and provided with a specially designed guide groove for use in mounting the disk drive on a device. The precision of devices has progressively been improved, and the further improvement of the shock resistance of the portable hard disk drive has been desired in recent years. The disk drive disclosed in the reference is provided with the shock absorbing members at its corners. The shock absorbing members are required to exercise their shock absorbing function satisfactorily even in a case where shocks act on parts of the disk drive other than the corners, such as a case where a flat part, such as a side wall, of the disk drive strike against some corner, or a case where secondary shocks act on aside wall, a bottom wall or a top wall after the disk drive has been dropped on the floor and shocks have acted on the corner.

For example, to meet the Compact Flash standards, the disk drive needs guide rails to insert terminals having a definite form factor in an adapter (card). In such a case, a necessary dimensional accuracy must be secured even if the guide rail is formed of a material that is difficult to form in dimensions within tolerance, such as a shock absorbing material for shock absorption.

### BRIEF SUMMARY OF THE INVENTION

Embodiments of the present invention provide a disk drive surrounded by a shock absorbing member to improve its shock resistance, and scarcely subject to deformation due to the thermal shrinkage of the shock absorbing member.

In accordance with an aspect of the present invention, a disk drive comprises a functional unit including a disk as information storage medium; a case for containing the functional unit; a wiring board provided with a connector beside one side thereof, and attached to the case; and a shock absorbing member covering side walls of the case excluding a side wall facing the connector; wherein the shock absorbing member has a part facing the connector and provided with a flexible part.

In accordance with another aspect of the invention, a disk drive comprises a bottom cover; a wiring board contained in the bottom cover and provided with a connector near one side thereof; a base plate disposed on the wiring board so that the connector is near one side thereof; a disk and a head contained in the base plate; a top cover covering an open upper end of the base plate; and a shock-absorbing member covering the side walls of the base plate excluding a side wall facing the connector; wherein slots are formed in side walls, adjacent to the connector, of the shock-absorbing member, and a flexible part is formed in a part, facing the connector, of the shock absorbing member.

In some embodiments, the flexible part is formed in a middle part of the part, facing the connector, of the shock absorbing member. In other embodiments, the flexible part is formed by curving the shock absorbing member. The flexible part may have a curved portion formed by curving the shock absorbing member, and slits formed above and below, respectively, of the curved portion. The shock absorbing member may be a frame bumper including elastic members. Alternatively, the shock absorbing member may be a frame bumper including a hard, elastic inner part, and a soft, elastic outer part. The hard, elastic inner part is formed of a polycarbonate resin or a nylon resin, and the soft elastic outer part is formed of a polyester elastomer.

According to embodiments of the present invention, the disk drive surrounded by the shock absorbing member is insignificantly subject to the deformation of the shock absorbing member resulting from thermal shrinkage.

### BRIEF DESCRIPTION OF THE DRAWINGS

FIG. 1 is a perspective view of a frame bumper included in a disk drive in a specific embodiment according to the present invention.

FIG. 2 s an exploded perspective view of the disk drive in the specific embodiment according to the present invention.

FIG. 3 is an upper perspective view of the disk drive formed by assembling component parts shown in FIG. 2.

FIG. 4 is an upper perspective view of the disk drive shown in FIG. 3 with a top cover put on a base plate.

FIG. 5 is a perspective view of a disk drive and a PC card in which the disk drive is to be inserted.

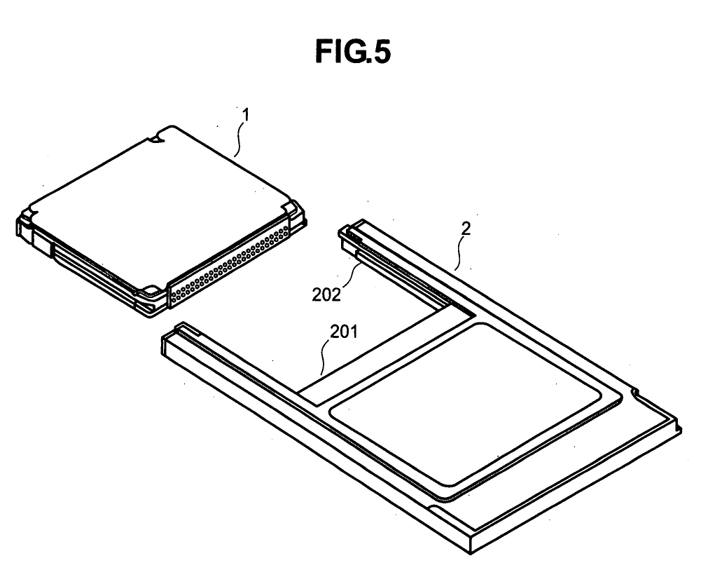

### DETAILED DESCRIPTION OF THE INVENTION

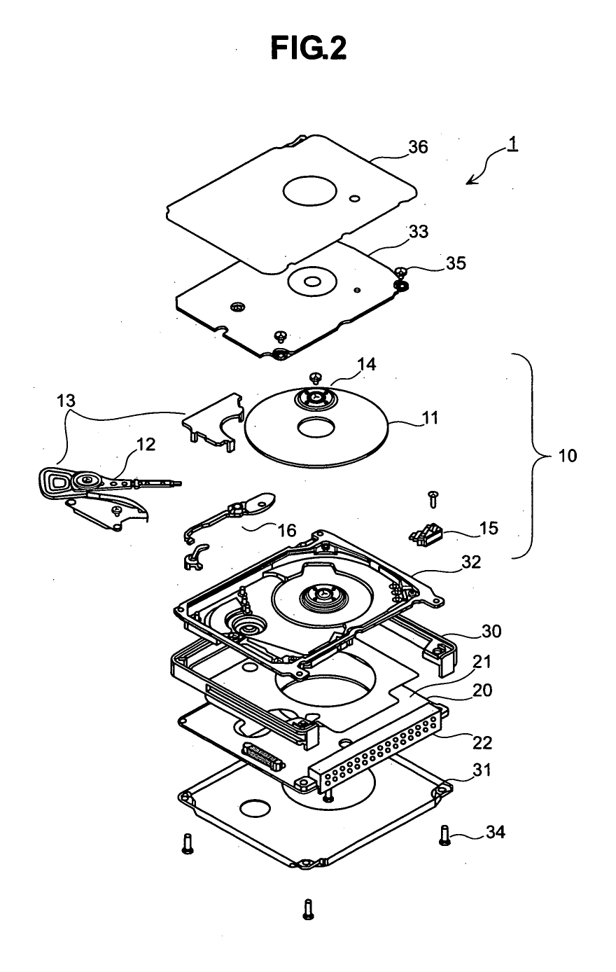

FIG. 2 is a view of assistance in explaining the assembly of a disk drive 1 in a specific embodiment according to the present invention. The disk drive 1 in this embodiment as a storage medium conforming to the Compact Flash Type 2 standards, and a portable precision device includes a functional unit 10, i.e., a built-in recording/reproducing unit for recording and reproducing data, and a card assembly 20 including circuits for driving and controlling the functional unit 10 and data input/output operation. The functional unit 10, the card assembly 20 and the like are contained in a case. The card assembly 20 includes a wiring board 21 provided on one side thereof with a connector (interface connector) 22 meeting function and construction having a form factor specified by Compact Flush Type 2 standards. One side of the connector 22 extends toward a bottom cover 31.

The functional unit 10 includes a magnetic disk (disk) 11, i.e., a data storage medium, supported for rotation; an actuator assembly 12 supporting on its tip part a read/write head for reading data from and writing data to the magnetic disk 11; a voice coil motor assembly (VCM assembly) 13 including a VCM coil and a VCM magnet; a top clamp 14 for clamping the magnetic disk 11 mounted on a spindle motor, not shown; a ramp mechanism 15 for supporting the read/write head when the read/write head is retracted from the magnetic disk 11; and a latching mechanism 16, such as a magnetic latch or an inertia latch, for holding the read/write head on the ramp mechanism 15 when the disk drive 1 is inoperative.

A case includes a frame bumper 30 having a form factor specified by the Compact Flash Type 2 standards, and formed of an elastic member as a shock-absorbing member (cushioning member), a bottom cover 31 for supporting the components of the disk drive 1, a base plate 32 containing the components of the functional unit 10, and a top cover 33 for covering the functional unit 10 contained in the base plate 32.

Bottom cover fastening screws 34 are passed through the bottom cover 31, the card assembly 20 and the frame bumper 30, and are screwed in threaded holes formed in the base plate 32 to fasten together the bottom cover 31, the card assembly 20, the frame bumper 30 and the base plate 32. The top cover 33 is fastened to the base plate 32 with top cover fastening screws 35. A seal 36 covers gaps between the edges of the top cover 33 and the base plate 32, and the heads of the top cover fastening screws 35.

The base plate 32 has hitherto been an aluminum casting made by die casting aluminum. Aluminum castings formed by die casting have very low shock resistance. This embodiment employs the frame bumper 30 formed of a shock absorbing material instead of a cast frame. The base plate 32 can be formed by processing a metal sheet by press working, and the shock-absorbing frame bumper 30 is used instead of thick parts formed by casting. Thus, the base plate 32 can be manufactured at a low manufacturing cost. The base plate 32 may be formed by die casting aluminum, and may be combined with the frame bumper 30. However, it is desirable in view of manufacturing cost and mass production to form the base plate 32 by press working.

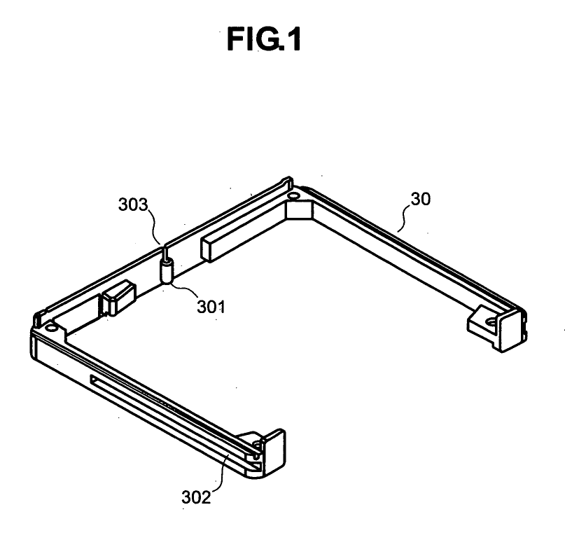

Referring to FIG. 1 showing the frame bumper 30 in a bottom perspective view, the frame bumper 30, i.e., a shock absorbing member, is a molding having side slots 302 required of the Compact Flash Type 2. The frame bumper 30 is formed of a thermoplastic elastomer, such as a polyester elastomer, has moderate elasticity and is excellent in dimensional stability.

The frame bumper 30 has a stretchable, curved, flexible part 301. The curved, flexible part 301 extends or contracts to absorb deformation of the frame bumper 30 due to thermal shrinkage. The flexible part 301 is formed in a substantially middle part of a cross part between side parts provided with the side slots 302. Slits 303 are formed on the upper and the lower side of the flexible part 301. the frame bumper 30 is able to warp upward and downward relative to the flexible part 301. The width of the cross part provided with the flexible part 301 is greater than that of the side parts provided with the side slots 302. The cross part extends toward the bottom cover 31 so as to cover the bottom cover 31. Likewise, parts of the frame bumper 30 corresponding to both sides of the connector 22 extend toward the bottom cover 31 so as to cover the bottom cover 31 together with a lower part of the connector 22.

The placement of the frame bumper 30, i.e., a shock absorbing member, in a middle part of an assembled structure absorbs shocks that act on parts on the side of the top cover 33 or those that act on parts on the side of the bottom cover 31 very effectively. The frame bumper 30 is formed of a resin by two-color molding. Since the frame bumper 30 is configured to have both a function as a shock absorbing member and a function as side slots, the frame bumper 30 has, for example, a core part (inner part) formed of a comparatively hard resin, such as a polycarbonate resin or a nylon resin, and a comparatively soft skin part (outer part) formed of a comparatively hard resin, such as a polyester elastomer. Thus, the frame bumper 30 formed by two-color molding has improved shock resistance.

The base plate 32 is formed of a metal. If the base plate 32 is formed of a resin, the base plate 32 having sufficient strength will occupy a larger space. In this embodiment, the frame bumper 30 of resins formed by two-color molding, and the base plate 32 of a metal are formed separately to place the frame bumper 30 and the base plate 32 in a narrow space.

The frame bumper 30 formed of the thermoplastic elastomer, such as a polyester elastomer, surrounds the metal base plate 32. Although the frame bumper 30 deforms greatly due to difference in thermal shrinkage between the frame bumper 30 and the base plate 32, the flexible part 301 extends or contracts to absorb the deformation and hence the shape of the disk drive changes scarcely. Since the frame bumper 30 can be stretched and deformed to attach the same to the base plate 32, the external shape of the disk drive can be maintained.

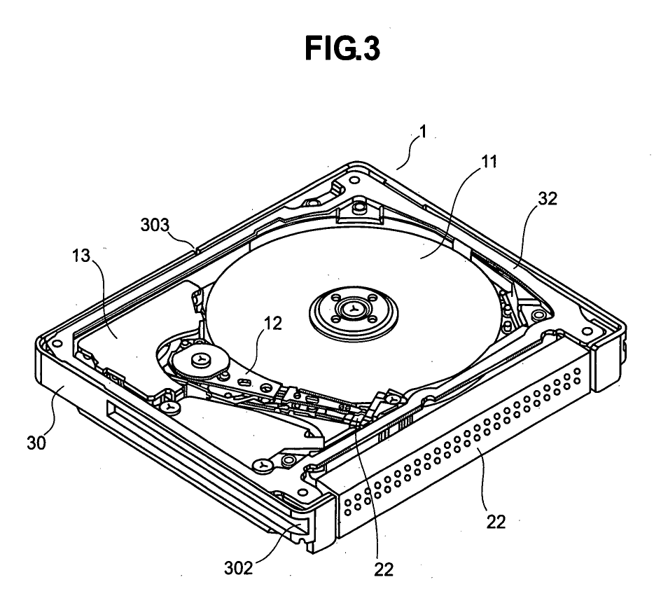

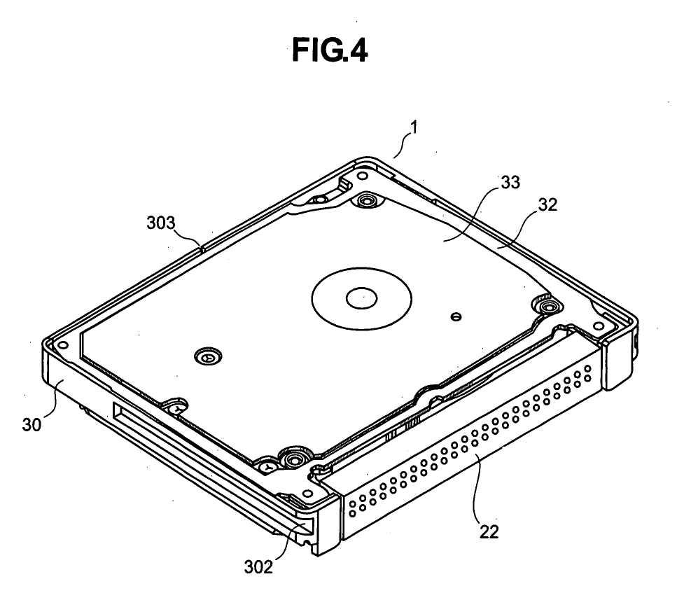

FIG. 3 is an upper perspective view of the disk drive 1 formed by assembling the component members shown in FIG. 2 with the top cover 33 removed. FIG. 4 is an upper perspective view of the disk drive 1 with the top cover 33 attached to the base plate with the three top cover fastening screws 35 removed. The frame bumper 30, i.e., a shock absorbing member, forms the side walls of the disk drive 1 in this embodiment. The perimeter of the frame bumper 30 is greater than that of the base plate 32 by 5 to 1 mm, and forms a plane equivalent to that of the connector 22. The thickness of parts, corresponding to the corners which are most likely to be exposed to shocks, of the frame bumper 30 are increased. Thus, the disk drive 1 can be protected from lateral shocks by surrounding the perimeter (side surfaces) of the base plate 32 by the frame bumper 30 and the connector 22.

The disk drive 1 in this embodiment having the form factor specified by the Compact Flash Type 2 standards is highly portable and transportable. The disk drive 1 is capable of absorbing shocks given thereto. Part of the frame bumper 30 and the connector 22 form the outer surfaces of the disk drive 1, and the base frame 32 and the top cover 33 are designed so that the edges thereof lie inside the frame bumper 30 and the connector 22. Therefore, when the disk drive 1 is dropped on the floor, the frame bumper 30 strikes the floor first to reduce shocks that act on the main part of the disk drive 1 to the least extent.

Although the frame bumper 30 formed of the thermoplastic elastomer, such as the polyester elastomer, and surrounding the metal base plate 32 deforms greatly due to difference in thermal shrinkage between the frame bumper 30 and the base plate 32, the deformation of the frame bumper 30 does not affect the external shape of the disk drive 1 to any significant extent because the flexible part 301 extends or contracts to absorb the deformation. Since the frame bumper 30 can be stretched and deformed to attach the same to the base plate 32, the external shape of the disk drive can be maintained.

1. A disk drive comprising:
a functional unit including a disk as an information recording medium;
a case for containing the functional unit;
a wiring board including a connector adjacent one side thereof, and attached to the case; and
a shock-absorbing member covering side walls of the case excluding a side wall facing the connector;
wherein the shock absorbing member has a part facing the connector and including a flexible part.

2. The disk drive according to claim 1, wherein the flexible part is formed in a middle part of the part, facing the connector, of the shock-absorbing member.

3. The disk drive according to claim 1, wherein the flexible part is formed by curving the shock absorbing member.

4. The disk drive according to claim 1, wherein the flexible part has a curved portion formed by curving the shock absorbing member, and slits.

5. The disk drive according to claim 1, wherein the shock absorbing member is a frame bumper including elastic members.

6. The disk drive according to claim 1, wherein the shock absorbing member is a frame bumper including a hard, elastic inner part, and a soft, elastic outer part.

7. The disk drive according to claim 6, wherein the hard, elastic inner part is formed of a polycarbonate resin or a nylon resin, and the soft elastic outer part is formed of a polyester elastomer.

8. A disk drive comprising:
a bottom cover;
a wiring board contained in the bottom cover and including a connector near one side thereof;
a base plate disposed on the wiring board so that the connector is near one side thereof;
a disk and a head contained in the base plate;
a top cover covering the open upper end of the base plate; and
a shock absorbing member covering the side walls of the base plate excluding a side wall facing the connector;
wherein slots are formed in side walls, adjacent to the connector, of the shock-absorbing member, and a flexible part is formed in a part, facing the connector, of the shock absorbing member.

9. The disk drive according to claim 8, wherein the flexible part is formed in a middle part of the part, facing the connector, of the shock-absorbing member.

10. The disk drive according to claim 8, wherein the flexible part is formed by curving the shock absorbing member.

11. The disk drive according to claim 8, wherein the flexible part has a curved portion formed by curving the shock absorbing member, and slits.

12. The disk drive according to claim 8, wherein the shock absorbing member is a frame bumper including elastic members.

13. The disk drive according to claim 8, wherein the shock absorbing member is a frame bumper including a hard, elastic inner part, and a soft, elastic outer part.

14. The disk drive according to claim 13, wherein the hard, elastic inner part is formed of a polycarbonate resin or a nylon resin, and the soft elastic outer part is formed of a polyester elastomer.

15. A magnetic disk drive comprising:
a bottom cover;
a wiring board contained in the bottom cover and including a connector near one side thereof;
a base plate disposed on the wiring board so that the connector is near one side thereof;
an actuator assembly including a disk contained in the base plate, and a head supported on a tip thereof;
a top cover covering an open upper end of the base plate; and
a frame bumper serving as a shock-absorbing member, and covering the side walls of the base plate excluding a side wall facing the connector;
wherein a flexible part is formed in a part, facing the connector, of the frame bumper.

16. The magnetic disk drive according to claim 15, wherein the flexible part is formed in a middle part of the part, facing the connector, of the shock-absorbing member.

17. The magnetic disk drive according to claim 15, wherein the flexible part is formed by curving the shock-absorbing member.

18. The magnetic disk drive according to claim 15, wherein the flexible part has a curved portion formed by curving the shock absorbing member, and slits.

19. The magnetic disk drive according to claim 15, wherein the frame bumper includes a hard, elastic inner part, and a soft, elastic outer part.

20. The magnetic disk drive according to claim 15, wherein the hard, elastic inner part is formed of a polycarbonate resin or a nylon resin, and the soft elastic outer part is formed of a polyester elastomer.
